(19) United States
(12) Patent Application Publication
(10) Pub. No.: US 2011/0274863 A1
(43) Pub. Date: Nov. 10, 2011

(54) THERMAL INSULATING TAPE WITH FIRE PROTECTING SYSTEM AND ITS USE IN AIRCRAFT CONSTRUCTION

(75) Inventors: Heinz-Peter Busch, Weyhe (DE); Berend Schoke, Twistringen (DE)

(73) Assignee: AIRBUS OPERATIONS GMBH, Hamburg (DE)

(21) Appl. No.: 13/089,353

(22) Filed: Apr. 19, 2011

Related U.S. Application Data
(60) Provisional application No. 61/330,958, filed on May 4, 2010.

(30) Foreign Application Priority Data
May 4, 2010 (DE) 10 2010 019 382.8

(51) Int. Cl. F16L 59/02; B32B 15/082; E04B 1/82; F16L 9/14; H01B 7/29; C09J 7/02; H01B 17/56

(52) U.S. Cl. 428/41.7; 428/344; 428/335; 138/141; 174/110 R; 181/284

(57) ABSTRACT

A thermal insulating tape is configured for fire protection for use in aircraft construction. The insulating tape has a multilayer construction including a flexible carrier tape providing protection against burn-through, the carrier tape being formed as a thermally conductive metal tape. An adhesive film is disposed on a first side of the carrier tape and is configured for partial fixation or complete wrapping of the insulating tape on a protected component. A flexible intumescent coating is disposed on a second side of the carrier tape.

### CROSS REFERENCE TO RELATED APPLICATIONS

This application claims priority to U.S. Provisional Patent Application Ser. No. 61/330,958, filed May 4, 2010 and German Patent Application No. DE 10 2010 019 382.8-43, filed May 4, 2010, which are both hereby incorporated by reference herein in their entirety.

### FIELD

The invention relates to a thermal insulating tape with a fire protection function for use in aircraft construction, with the insulating tape having a multilayer design.

### BACKGROUND

According to the generally known state of the art, for protecting electrical cables from damaging fire temperatures, predominantly heat-resistant woven materials are used, by means of which materials cable harnesses or single cables are manually wrapped in an elaborate manner. Predominantly a woven quartz material is used as a heat-resistant material, which woven quartz material needs to be bound at short distances by means of a yarn that is also heat resistant. In contrast to this, pipes that are resistant to burn-through, which pipes can be used as hydraulics lines or fuel lines, usually have to be produced in an expensive manner from titanium.

EP 0 229 331 E1 describes a thermal insulating material that is suitable for electrical cables. This insulating material is designed as an insulating tape which is used for wrapping around electrical cables. The insulating tape comprises a first layer of a mica paper sheet on one side of which a reinforcement sheet has been applied. For applying the reinforcement sheet to the mica paper sheet a special binder is required that comprises a polysiloxane resin with the addition of a curing catalyst.

On the other side of the mica paper sheet an adhesive layer has been applied which comprises a pressure-sensitive adhesive coat made of a curable polysiloxane resin without a curing catalyst and which maintains its adhesive strength over a very long period of time. As a result of the special adhesive layer the insulating tape can be permanently wrapped around the electrical cable that requires thermal insulation, with the mica paper sheet ensuring adequate protection against heat. Preferably it is recommended that muscovite or phlogopite be used for this purpose. In contrast to this, the reinforcing sheet can comprise a woven glass material. This special layer design of the thermal insulating tape, as well as the production of the composite of said materials, appears to be quite elaborate from the point of view of production technology.

WO 82/04419 describes another technical solution for thermally insulating electrical cables, which solution among other things also involves a thermal insulating tape with quite a simple layer design. In one of the described embodiments it is proposed that an electrical cable harness comprising several individual cables first be provided with simple sheathing that is used for fixing, which in turn is completely wrapped in a helical manner with a thermal insulating tape.

The thermal insulating tape essentially comprises a special putty that has been applied as a coating onto a flexible carrier tape. The special putty comprises chemically bound water which is released when exposed to heat so as to provide a degree of protection against burn-through for a relatively long period of time. Furthermore, the putty also comprises fire-retardant gases, a reflective surface, and is moreover intumescent.

Intumescent materials are predominantly used as sealing materials; during thermal exposure as a result of foaming they cause closure of residual openings, thus preventing smoke and toxic gases from passing through. By means of the heat removal caused as a result of the above, the expansion process of the material prevents burn-out of components, for example in a fire protection wall. The fire protection characteristics of the thermal insulating tape are thus determined solely by the composition of the special putty, which needs to be used at a quite considerable material thickness in order to achieve the desired fire protection characteristics.

### SUMMARY

An aspect of the present invention is to create a thermal insulating tape comprising a fire protection function, which tape is simple to install and with little thickness ensures a high degree of fire protection safety.

In an embodiment, the present invention provides a thermal insulating tape configured for fire protection for use in aircraft construction. The insulating tape has a multilayer construction including a flexible carrier tape providing protection against burn-through, the carrier tape being formed as a thermally conductive metal tape. An adhesive film is disposed on a first side of the carrier tape and is configured for partial fixation or complete wrapping of the insulating tape on a protected component. A flexible intumescent coating is disposed on a second side of the carrier tape.

### BRIEF DESCRIPTION OF THE DRAWINGS

Exemplary embodiments of the present invention are described in more detail below with reference to the drawings, in which:

FIG. 1 shows a diagrammatic lateral view of a multilayer thermal insulating tape;

FIG. 2 shows a lateral view of an electrical cable arrangement with a singly-wrapped thermal insulating tape;

FIG. 3 shows a lateral view of a fluidic pipe arrangement with a doubly-wrapped thermal insulating tape;

FIG. 4 shows a front view of an insulating pad arrangement with a thermal insulating tape partially applied to the aforesaid; and

FIG. 5 shows a diagrammatic front view of a lining arrangement with a thermal insulating tape partially applied to the aforesaid.

### DETAILED DESCRIPTION

In an embodiment, the invention provides a thermal insulating tape with a fire protection function for use in aircraft construction, with the insulating tape having a multilayer design comprising a flexible carrier tape made of a material that provides protection against burn-through, which on one side comprises an adhesive film for complete wrapping around or partial affixation to a component to be protected. Furthermore, other embodiments of the invention relate, also in special aircraft-engineering applications, to an electrical cable arrangement, a fluid pipe arrangement, an insulating pad arrangement as well as an interior lining arrangement of an aircraft, in which arrangements a thermal insulating tape of the type mentioned above is used.

The field of application of the present invention thus predominantly relates to aircraft construction. Because of special safety regulations relating to resistance to burn-through in aircraft construction, suitable technical measures are taken in order to, for example, correspondingly protect electrical or fluidic lines. However, apart from such lines, sheet-like components, in particular the insulating pads used in the wall construction of aircraft fuselages for thermal or acoustic primary insulation, or other lining arrangements, for example used as cargo hold lining, also require corresponding protection.

In an embodiment, the invention provides a carrier tape of a thermal insulating tape that is designed as a heat-conducting metal tape, to one side of which the adhesive film for fixing to the component to be protected has been applied, wherein the opposite side of said carrier tape comprises a flexible intumescent coating.

Thus, embodiments of the invention provide an advantage in particular in that in the multilayer thermal insulating tape both the carrier tape and the intumescent coating contribute to burn-through protection. Because, depending on the required resistance to burn-through, the thickness of the metal tape, which preferably comprises aluminium, can be varied, which metal tape because of its thermal conduction characteristics distributes the input heat in a sheet-like manner thus locally reducing said heat.

Furthermore, the intumescent coating prevents fast local heating of the metal tape in the case of a fire, thus safeguarding the effectiveness of said metal tape. In this manner the component to be protected is effectively protected not only against direct exposure to flames but also against the release of combustion gases and smoke, because the intumescent coating of the insulating tape foams in the case of a fire, thus providing an insulating protective layer in the form of a thermally resistant foam.

Preferably, flexible plastics comprising expanded graphite form a suitable intumescent coating for the thermal insulating tape according to embodiments of the invention.

For the range of applications covered according to embodiments of the invention, the flexible carrier tape, which preferably comprises an aluminium foil, should have a thickness of preferably 20 to 30 micrometers, more preferably 25 micrometers. In this thickness range adequate flexibility for use as an insulating tape is provided, while at the same time maximum protection against burn-through is achieved. Besides, the thicker the aluminium foil, the greater is the desired thermal conductance for distributing locally concentrated heat over a larger surface.

It is further proposed to design the adhesive film of the thermal insulating tape as a transfer-type adhesive film, preferably on an acrylate base. In this way considerable heat-resistant adhesive properties both relating to the component to be protected, and relating to the metal tape to be coated with adhesive film are to be achieved. In addition, such an adhesive film can comprise a detachable protective paper in order to make it possible to provide the insulating tape in roll form.

In the field relating to aircraft the special thermal insulating tape described above can preferably be used in the following different applications:

The thermal insulating tape can form part of an electrical cable arrangement that is formed by wrapping an individual cable or a cable harness.

Analogous to this, a fluid-pipe arrangement for fluidically connecting devices installed in an aircraft can be formed in that a corresponding pipe bundle or a single pipe comprising aluminium or plastic is wrapped on the outer circumference by means of the thermal insulating tape according to the invention. To this extent it is not necessary to expensively construct from titanium a fluid pipe that is resistant to burn-through.

According to another special application case, an insulating pad arrangement for thermal and/or acoustic primary insulation of structural components installed in an aircraft can partially comprise the thermal insulating tape. This relates, in particular, to pipe passageways through this type of insulating pads which comprise slits towards the edge so as to make it possible to install or deinstall the insulating pad on the pipe to be fed through, without the pipe itself having to be deinstalled for this purpose. The slit that facilitates installation can subsequently be covered by means of the thermal insulating tape. In this way the same degree of resistance to burn-through can be achieved as is the case with those regions of the insulating pad that do not have slits.

Furthermore, lining arrangements such as cargo compartment linings, cargo compartment door linings and the like installed in an aircraft can be coated by means of the thermal insulating tape at least in those positions on which additional measures relating to resistance to burn-through are required, for example for edge protection and covering slits. To this extent the thermal insulating tape according to the invention replaces the intumescent seals otherwise used for this application purpose. In contrast to applying such a seal, sticking on the adhesive thermal insulating tape is faster, neater, and furthermore allows simplified stock holding. In particular it is possible to treat repair positions on lining components with said insulating tape.

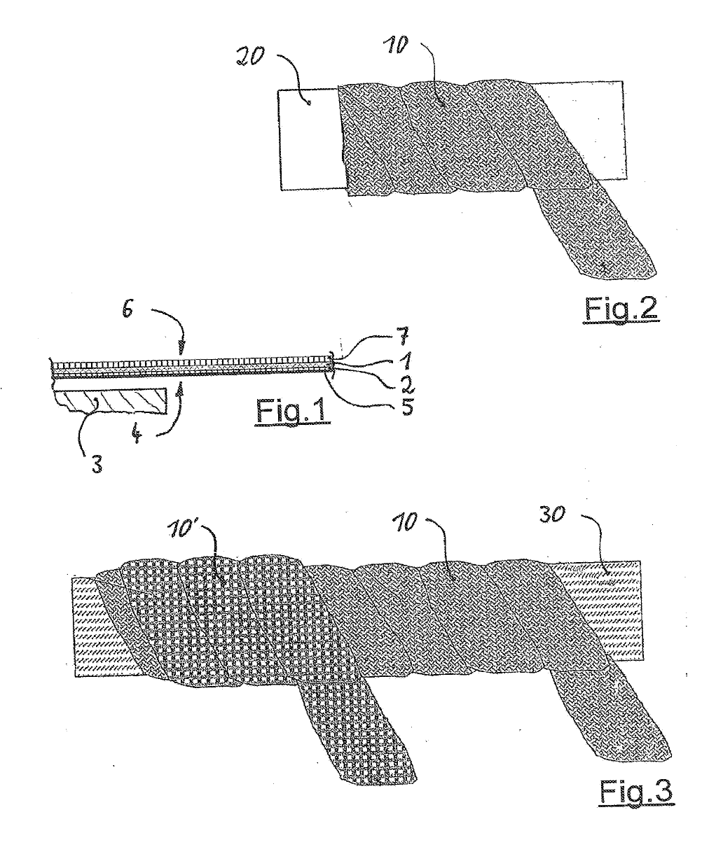

FIG. 1 shows a thermal insulating tape including a flexible carrier tape 1 made of aluminium foil as a material protecting against burn-through. In this arrangement the carrier tape 1 is 25 micrometers in thickness. Towards one side the carrier tape 1 comprises an adhesive film 2 for affixation to a component 3 (only diagrammatically indicated in the diagram). In this arrangement the adhesive film 2 is affixed to the underside 4 of the carrier tape 1 and is designed as a transfer-type adhesive film on an acrylate base. In its non-applied state the adhesive film 2 is covered by a detachable protective paper 5. On the side 6, which is opposite side 4, the carrier tape 1 comprises an intumescent coating 7.

The carrier tape 1 together with the adhesive film 2 with the detachable protective paper 5 and, towards the other side 6, with the intumescent coating 7 can be produced in roll form.

According to FIG. 2 this thermal insulating tape, which has been provided in this manner ready for use, is wound onto a cable harness 20 that comprises individual electrical cables and together with the thermal insulating tape 10 wound onto the outer circumference forms an electrical cable arrangement, which provides protection against burn-through, for electrically connecting devices installed in an aircraft.

According to FIG. 3 an individual pipe 30 comprising aluminium is similarly wrapped with the use of a thermal insulating tape 10, wherein in this arrangement a further wrapping layer of insulating tape 10′ is applied so as to cover the joint gaps in order to achieve a higher degree of resistance to burn-through.

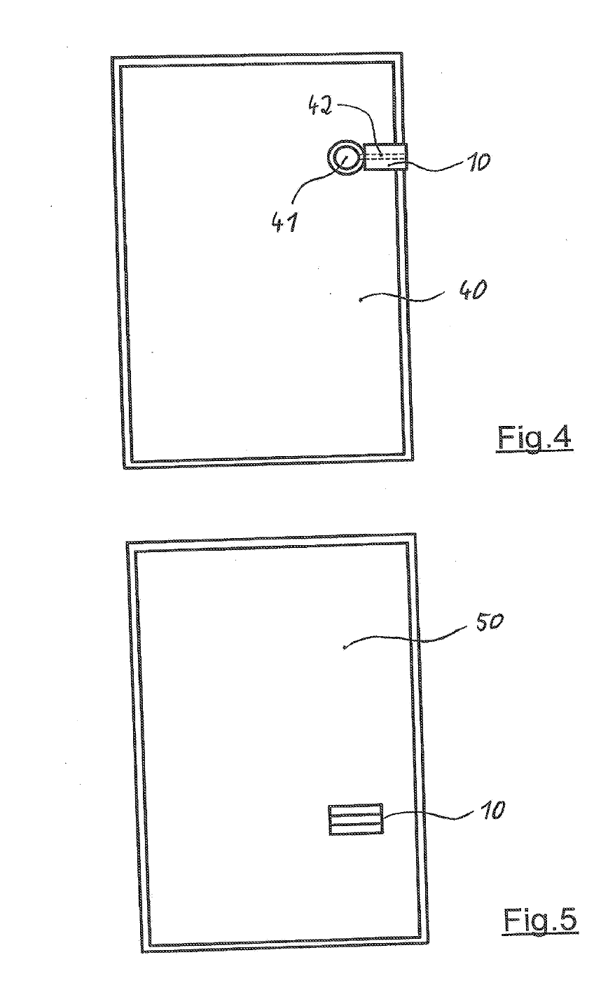

According to FIG. 4, an insulating pad 40 for thermal and acoustic primary insulation of components of the aircraft comprises a cut-out 41 for feeding through pipes and the like, which cut-out 41 is open by means of a slit 42 that leads to the edge region so that the insulating pad 40 can be installed and deinstalled independently of the pipeline. For closing the slit 42 after installation the thermal insulating tape 10 is glued in a U-shaped manner from the direction of the edge region of the insulating pad 40 so that it covers the slit 42. Overall this results in a closed surface again that provides a high degree of resistance to burn-through. Apart from this, the insulating pad 40 comprises a glass wool filling that is enclosed by a cover made of foil, which cover forms a fire barrier.

In the application example according to FIG. 5 a lining arrangement comprising a lining panel 50 is formed, which covers a structural component of an aircraft. In a repair position, for the purpose of restoring adequate resistance to burn-through, the lining panel 50 in part comprises several pieces of thermal insulating tape 10 according to an embodiment of the invention, which pieces are arranged side by side and are stuck onto said lining panel 50.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

While the invention has been particularly shown and described with reference to preferred embodiments thereof, it will be understood by those skilled in the art that various changes in form and details may be made therein without departing from the spirit and scope of the invention.

### LIST OF REFERENCE CHARACTERS

1 Carrier tape
2 Adhesive film
3 Component
4 One side
5 Protective paper
6 Other side
7 Intumescent lining
10 Insulating tape
20 Cable harness
30 Single pipe
40 Insulating pad
41 Cut-out
42 Slot
50 Lining panel

What is claimed is:

1. A thermal insulating tape configured for fire protection for use in aircraft construction, the insulating tape having a multilayer construction and comprising:
a flexible carrier tape providing protection against burn-through, the carrier tape being formed as a thermally conductive metal tape;
an adhesive film disposed on a first side of the carrier tape, the adhesive film configured for partial fixation or complete wrapping of the insulating tape on a protected component; and
a flexible intumescent coating disposed on a second side of the carrier tape.

2. The thermal insulating tape recited in claim 1 wherein the intumescent coating includes a plastic material containing an expanded graphite.

3. The thermal insulating tape recited in claim 1, wherein the thermally conductive metal tape includes aluminum foil.

4. The thermal insulating tape recited in claim 3, wherein the carrier tape has a thickness in a range of 20 to 30 micrometers.

5. The thermal insulating tape recited in claim 1, wherein the carrier tape, the adhesive film, and the intumescent coating form a flexible multilayer compound structure, the compound structure being configured for production in a roll form.

6. The thermal insulating tape recited in claim 1, wherein the adhesive film is a transfer-type adhesive file on an acrylate base.

7. The thermal insulating tape recited in claim 5, wherein the adhesive film includes a detachable protective paper so as to enable impermanent rolling of the insulating tape into the roll form.

8. An electrical cable arrangement for electrically connecting devices installed in an aircraft, the electrical cable comprising:
a cable member including at least one of a cable and a cable harness; and
a thermal insulating tape wound around an outer circumference of the cable member, the thermal insulating tape having a multilayer construction and including;
a flexible carrier tape providing protection against burn-through, the carrier tape being formed as a thermally conductive metal tape,
an adhesive film disposed on a first side of the carrier tape, and
a flexible intumescent coating disposed on a second side of the carrier tape.

9. A fluid-pipe arrangement for providing a fluid connection between devices installed in an aircraft, the fluid-pipe arrangement comprising:
a pipe component including one of a pipe bundle and a single pipe made of aluminum; and
a thermal insulating tape wound around an outer circumference of the pipe component, the thermal insulating tape having a multilayer construction and including;
a flexible carrier tape providing protection against burn-through, the carrier tape being formed as a thermally conductive metal tape,
an adhesive film disposed on a first side of the carrier tape, and
a flexible intumescent coating disposed on a second side of the carrier tape.

10. An insulating pad arrangement for at least one of thermal and acoustic primary insulation of a structural component installed in an aircraft, the insulating pad arrangement comprising:
at least one insulating pad; and
a thermal insulating tape adhered to the at least one insulating pad, the thermal insulating tape having a multilayer construction and including;
a flexible carrier tape providing protection against burn-through, the carrier tape being formed as a thermally conductive metal tape,
an adhesive film disposed on a first side of the carrier tape, and
a flexible intumescent coating disposed on a second side of the carrier tape.

11. A lining arrangement for covering components installed in an aircraft, the lining arrangement comprising:
a lining panel; and
a thermal insulating tape adhered to the lining panel, the thermal insulating tape having a multilayer construction and including;
a flexible carrier tape providing protection against burn-through, the carrier tape being formed as a thermally conductive metal tape,
an adhesive film disposed on a first side of the carrier tape, and
a flexible intumescent coating disposed on a second side of the carrier tape.
